(19) United States
(12) Patent Application Publication
(10) Pub. No.: US 2016/0245513 A1
(43) Pub. Date: Aug. 25, 2016

(54) HEAT-PROTECTIVE INSERT FOR A FUEL LINE

(71) Applicant: SIEMENS AKTIENGESELLSCHAFT, München (DE)

(72) Inventors: Jürgen Buchheim, Berlin (DE); Andreas Böttcher, Mettmann (DE); Thomas Hauser, Strausberg (DE); Patrick Lapp, Berlin (DE)

(73) Assignee: Siemens Aktiengesellschaft, Munich (DE)

(21) Appl. No.: 15/027,477

(22) PCT Filed: Oct. 2, 2014
(86) PCT No.: PCT/EP2014/071188

§ 371 Date: Apr. 6, 2016

(30) Foreign Application Priority Data
Oct. 11, 2013 (DE) 10 2013 220 586.4

(51) Int. Cl. F23K 5/18; F16L 57/04; F16L 19/025

(52) U.S. Cl. CPC F23K 5/18; F16L 19/025; F16L 57/04

(57) ABSTRACT

A heat-protective insert for a fuel line, has a first portion in the form of a tube with a cross-section, and a second portion that is connected to the first portion, and extends across the cross-section, and has openings to achieve a sieve effect. A fuel line has such a heat-protective insert.

### CROSS REFERENCE TO RELATED APPLICATIONS

This application is the US National Stage of International Application No. PCT/EP2014/071188 filed Oct. 2, 2014, and claims the benefit thereof. The International Application claims the benefit of German Application No. DE 102013220586.4 filed Oct. 11, 2013. All of the applications are incorporated by reference herein in their entirety.

### FIELD OF INVENTION

The invention relates to a heat-protective insert for a fuel line, in particular comprising a fuel filter.

### BACKGROUND OF INVENTION

For fixing or connecting fuel lines, use is typically also made of screw connections. However, vibrations and temperature changes can cause these to come loose during operation. In order to reduce the influence of temperature changes, there have been developed heat-protective inserts which are inserted into the fuel lines in the region of the screw connections.

In addition to the heat-protective insert, cap filters are usually inserted into the fuel lines in order to protect the burner from impurities. In order to ensure that the filter is not lost, it is arranged, for example at a point at which two fuel pipes are screwed together, with a flange between the two pipes and is secured by means of the screw connection.

However, if a heat-protective pipe is introduced in the fuel line such that it protects the screw connection at which the filter is normally secured, it is then no longer possible for the filter to be installed at that location and a possible contamination of the burner can no longer be excluded.

It is possible to integrate the filter between the flange connection of the ring line and of the stub line to the burner, i.e. in the flow direction of a fuel upstream of the location used hitherto. However, this has the drawback, inter alia, that impurities in the gas line between the burner and the filter can enter the burner and block the burner nozzles.

### SUMMARY OF INVENTION

The invention has an object of further developing the above-mentioned device so as to ensure a high degree of protection both from heat and from impurities in the fuel, while making it as simple as possible to install and as cost-effective as possible to produce.

The invention achieves this object by providing that, in the case of a heat-protective insert for a fuel line, the heat-protective insert comprises a first part in the form of a pipe with a cross section and a second part which adjoins the first part and extends over the cross section and has openings to achieve a sieve effect.

In that context, it is expedient if the second part is formed at least partially as a cone. The result of this is an increased filter area in comparison to the flat filter.

Production is particularly simple and thus cost-effective if the openings are holes.

Also with a view to production costs, but also with a view to secure installation, it is advantageous if the first and second parts are formed from one piece.

It is particularly advantageous if, in the case of a fuel line comprising a first and a second pipe which are arranged one behind the other in the longitudinal direction and are connected to one another, the described heat protective insert is arranged in the pipes such that it extends at least partially into each pipe. In this manner, in particular the connection point is better protected from coming loose.

In that context, it is expedient in relation to assembly and maintenance if the two pipes are connected to one another by means of a screw connection.

In order that the heat-protective insert is secured in its position, it is particularly advantageous if, in the flow direction of a fuel, at at least one point in the downstream, pipe an inner diameter is smaller than an outer diameter of the heat-protective insert immediately upstream of this point.

The device according to the invention permits, with simple construction and simple installation, a cost-effective solution in comparison to the separate embodiment. In addition to the low complexity of installation, the maintenance burden is also negligible since it is no longer possible for the filter to come loose and thus securing means are no longer necessary. Above all, the device does away with any movable parts.

### BRIEF DESCRIPTION OF THE DRAWINGS

The invention will be explained in more detail by way of example with reference to the drawings. The drawings show, schematically and not to scale:

FIG. 1 a fuel line with a heat-protective insert and a fuel filter according to the prior art,

FIG. 2 a fuel line with an extended heat-protective insert without a fuel filter,

FIG. 3 a fuel line with a heat-protective insert having an integrated fuel filter according to the invention,

FIG. 4 a fuel line with a heat-protective insert having a modified integrated fuel filter according to the invention, and

FIG. 5 a fuel line with a heat-protective insert having an upstream integrated fuel filter according to the invention.

### DETAILED DESCRIPTION OF INVENTION

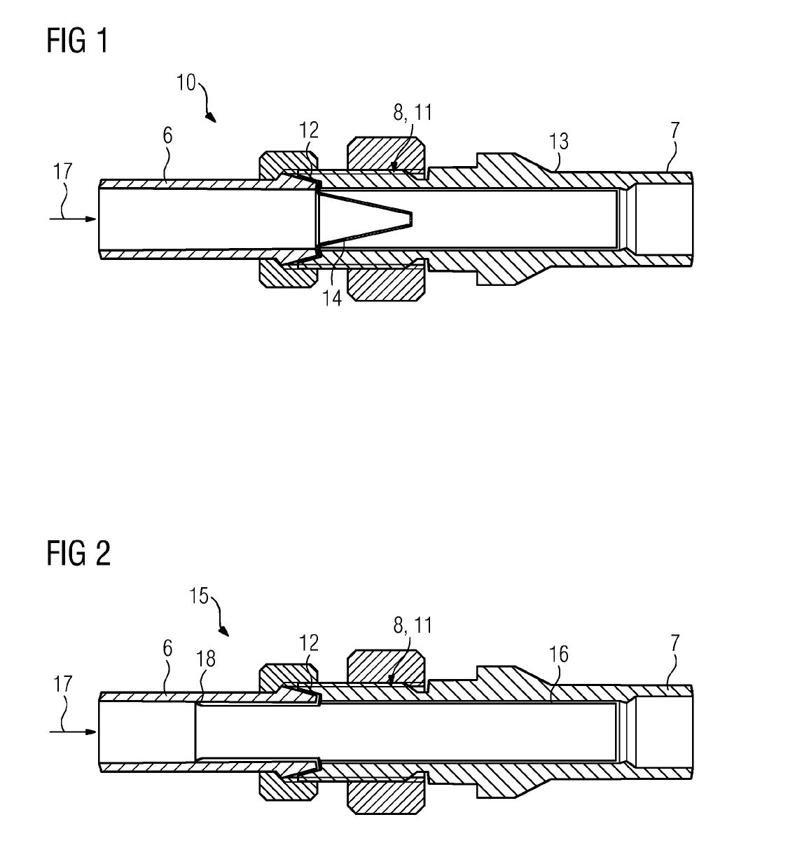

FIG. 1 shows, schematically and by way of example, a fuel line 10 according to the prior art with a first pipe 6 and a second pipe 7 which are arranged one behind the other in the longitudinal direction and are screwed together. The fuel line 10 is fixed in a plate (not shown) by means of a screw connection 8, what is termed a bulkhead fitting 11. The two pipes 6, 7 are screwed together by means of a taper-cone system 12. The heat-protective insert 13 according to the prior art is arranged in the second pipe 7 and thus provides thermal protection for the bulkhead fitting 11. What is termed a cap filter 14 is arranged in the flow direction of a fuel 17 upstream of the heat-protective insert 13 and is fixed between the two pipes 6, 7 in order to protect a downstream burner from impurities.

FIG. 2 shows another fuel line 15 according to the prior art with an extended heat-protective insert 16, providing thermal protection not only for the bulkhead fitting 11 but also for the screw connection with the taper-cone system 12. However, the extended heat-protective insert 16 does away with the cap filter 14 such that contamination of the burner becomes more likely. The inflow cone 18 provides a good seal between the heat-protective insert 16 and the first pipe 6 and means that the flow of the fuel in the fuel line 15 is as far as possible not impaired by installed parts.

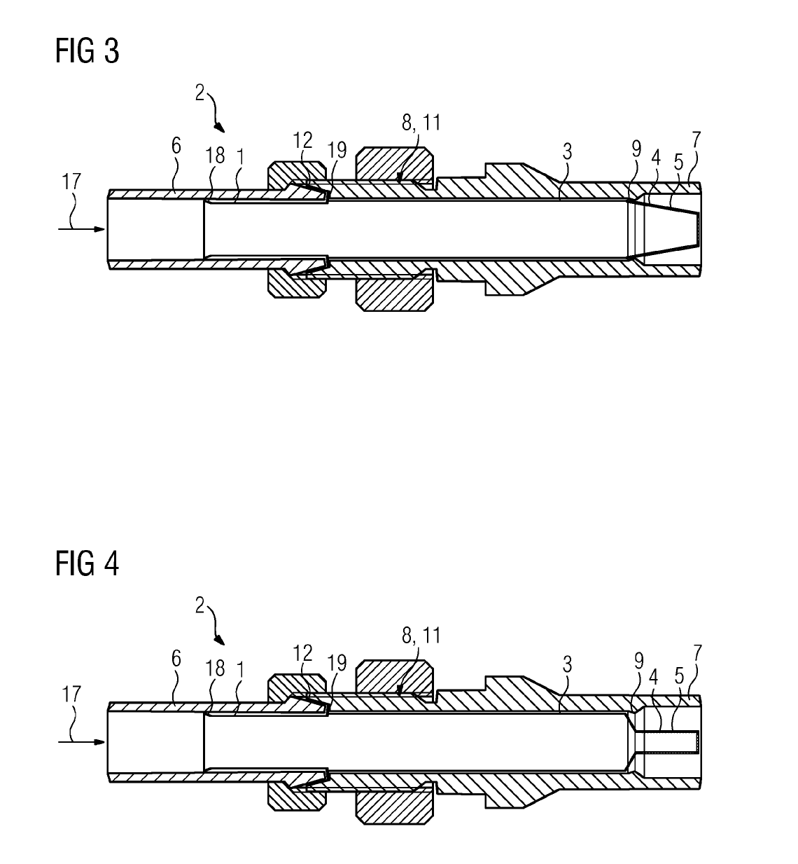

The solution, proposed by the invention, to the problems of thermal protection for the screw connections and to the need to filter the fuel as close as possible to the burner before it reaches the burner is illustrated in FIG. 3.

FIG. 3 namely shows a fuel line 2 comprising a first pipe 6 and a second pipe 7 which are arranged one behind the other in the longitudinal direction and, in the example of FIG. 3, are screwed together via a screw connection with a taper-cone system 12. In the pipes 6, 7, there is a heat-protective insert 1, comprising a first part 3 in the form of a pipe with a cross section and a second part 4 which adjoins the first part 3 and extends over the cross section and has openings 5 to achieve a sieve effect, which insert is arranged such that it extends at least partially into each pipe 6, 7.

It is therefore proposed to produce the filter and the heat-protective insert as one part. Thus, in addition to improved heat protection for both screw connections 11, 12, potential contamination is avoided.

Additional securing means, as would be necessary in the case of a screw-fitted filter, are omitted. The integrated design reduces the installation complexity and the maintenance burden.

If the heat-protective insert 1 is turned from solid material, it is possible to produce the pipe (first part 3) and the cone of the filter (second part 4) on the same machine. Then, it only remains to produce the fine holes 5 of the filter. This can expediently be performed by laser drilling, water jet cutting or electrical discharge machining.

In order also to secure the heat-protective insert 1 at the provided position in the fuel line 2, in the flow direction of a fuel, at at least one point 9 in the downstream, second pipe 7 an inner diameter is smaller than an outer diameter of the heat-protective insert 1 immediately upstream of this point 9. Furthermore, in particular in the region of the screw connection with the taper-cone system 12, that is to say at that point where the first 6 and second 7 pipes abut against one another, the heat-protective insert 1 can be secured by a circumferential web 19 or a type of flange.

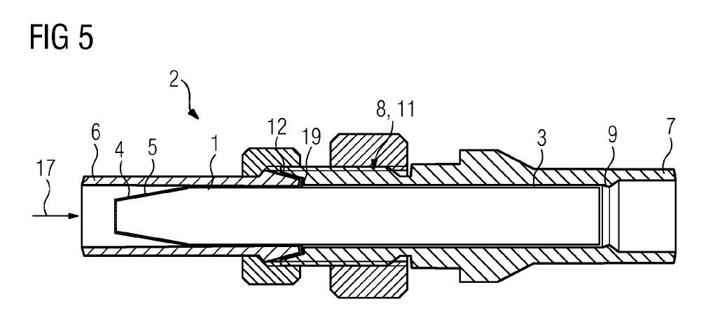

An alternative variant for reducing production costs in general, and the effort for internal machining in particular, is shown in FIG. 4. The illustrated shape of the filter (that is to say of the second part 4), provided with just one conical transition but essentially cylindrical, facilitates internal machining e.g. by drilling. In this context, the modified filter design must match the previous filter design in terms of volume and throughflow area.

Since the filter can be installed in two different directions, it is also possible to place the filter on the upstream side of the heat-protective insert 1. This embodiment simplifies production in particular by dispensing with an otherwise necessary inflow cone 18 on the upstream end of the first part 3.

1-7. (canceled)

8. A heat-protective insert for a fuel line, comprising:
a first part in the form of a pipe with a cross section, and
a second part which adjoins the first part and extends over the cross section and has openings to achieve a sieve effect,
wherein the first and second parts are formed from one piece.

9. The heat-protective insert as claimed in claim 8,
wherein the second part is formed at least partially as a cone.

10. The heat-protective insert as claimed in claim 8,
wherein the openings are holes.

11. A fuel line comprising:
a first and a second pipe which are arranged one behind the other in the longitudinal direction and are connected to one another,
a heat protective insert as claimed in claim 8,
wherein the heat protective insert is arranged in the pipes such that it extends at least partially into each pipe.

12. The fuel line as claimed in claim 11,
wherein the two pipes are connected to one another by means of a screw connection.

13. The fuel line as claimed in claim 11,
wherein, in the flow direction of a fuel, at at least one point in the downstream, second pipe an inner diameter is smaller than an outer diameter of the heat-protective insert immediately upstream of this point.
